(19) United States
(12) Patent Application Publication
(10) Pub. No.: US 2026/0162532 A1
(43) Pub. Date: Jun. 11, 2026

(54) VEHICULAR DRIVING ASSIST SYSTEM WITH EMERGENCY VEHICLE IDENTIFICATION

(71) Applicant: Magna Electronics Inc., Auburn Hills, MI (US)

(72) Inventor: Bishnu Raveendran, Rochester, MI (US)

(21) Appl. No.: 19/413,354

(22) Filed: Dec. 9, 2025

Related U.S. Application Data
(60) Provisional application No. 63/730,068, filed on Dec. 10, 2024.

(51) Int. Cl. G08G 1/0967; G08G 1/01; G08G 1/017; G08G 1/04; G08G 1/16

(52) U.S. Cl. CPC G08G 1/096783; G08G 1/0112; G08G 1/0175; G08G 1/04; G08G 1/166

(57) ABSTRACT

A vehicular driving assist system includes a plurality of microphones disposed at a vehicle equipped with the vehicular driving assist system. The vehicular driving assist system, via processing at an ECU of captured audio data, determines presence of a plurality of emergency vehicles. The vehicular driving assist system, for each determined emergency vehicle of the plurality of emergency vehicles, determines (i) a position of the determined emergency vehicle and (ii) a direction of travel of the determined emergency vehicle. The vehicular driving assist system generates an alert to a driver of the equipped vehicle, and the alert indicates the position of each determined emergency vehicle and the direction of travel of each determined emergency vehicle.

### CROSS REFERENCE TO RELATED APPLICATION

The present application claims the filing benefits of U.S. provisional application Ser. No. 63/730,068, filed Dec. 10, 2024, which is hereby incorporated herein by reference in its entirety.

### FIELD OF THE INVENTION

The present invention relates generally to a driving assist system for a vehicle and, more particularly, to a driving assist vision system that utilizes one or more microphones at a vehicle.

### BACKGROUND OF THE INVENTION

Use of acoustic sensors in vehicle sensing systems is common and known. Examples of such known systems are described in U.S. Pat. Nos. 9,800,983; 11,244,564 and/or 11,738,767, which are hereby incorporated herein by reference in their entireties.

### SUMMARY OF THE INVENTION

A vehicular driving assist system includes a plurality of microphones disposed at a vehicle equipped with the vehicular driving assist system. The microphones sense exterior of the equipped vehicle and capture audio data. The system includes an electronic control unit (ECU) with electronic circuitry and associated software. Audio data captured by the plurality of microphones is transferred to the ECU. The electronic circuitry of the ECU includes a data processor, and the data processor is operable to process audio data captured by the plurality of microphones and transferred to the ECU. The vehicular driving assist system, via processing at the ECU of captured audio data, determines presence of a plurality of emergency vehicles. The vehicular driving assist system, for each determined emergency vehicle of the plurality of emergency vehicles, determines (i) a position of the determined emergency vehicle and (ii) a direction of travel of the determined emergency vehicle. The vehicular driving assist system generates an alert to a driver of the equipped vehicle, and the alert indicates the position of each determined emergency vehicle and the direction of travel of each determined emergency vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with an alert system that incorporates microphones;

FIG. 2 is a block diagram of the alert system of FIG. 1; and

FIG. 3 is a block diagram of a model of the alert system of FIG. 1.

### DESCRIPTION OF THE PREFERRED EMBODIMENTS

Emergency vehicles, including ambulances, fire trucks, and police cars, are integral to public safety and life-saving operations. The rapid response of these vehicles is crucial, as every second can be pivotal in emergency situations. Granting them the right of way is important for enabling swift and efficient arrival at emergency scenes, potentially making the difference between life and death. It is important for drivers to remain vigilant and yield to emergency vehicles to facilitate reduced response times and improved emergency outcomes.

Navigating intersections presents significant collision risks for emergency vehicles due to the high potential for accidents. These intersections are frequently congested and chaotic, particularly during peak traffic hours. Emergency vehicles, which must move swiftly and may need to cross intersections against traffic signals, depend on other drivers to be vigilant and yield the right of way. However, not all drivers may notice or react promptly, leading to hazardous situations for the emergency vehicle and other vehicles. Often, automobile drivers operate within soundproofed cabins, frequently accompanied by audio systems, which significantly diminish their ability to perceive external auditory signals, such as those emitted by approaching emergency vehicles. Thus, the combination of high vehicular driving speeds, unpredictable driver behavior, and the complexity of traffic patterns at junctions increases the likelihood of collisions and other accidents. Increasing driver awareness of the presence of emergency vehicles and emphasizing the importance of drivers yielding to emergency vehicles can help mitigate these risks and increase safety for emergency vehicles and other vehicles as the emergency vehicles pass through intersections and navigate roadways.

Accordingly, implementations described herein include an advanced sound detection system and/or an alert system and/or a vehicular driving assist system designed to recognize the auditory signals emitted by approaching emergency vehicles. This system is engineered to alert a driver of a vehicle equipped with the advanced sound detection system to the presence of such emergency vehicles, thereby enhancing situational awareness of the driver and safety of the equipped vehicle. The described system employs a sound-based detection mechanism, which may serve as a complementary augmentation to vision-based detection systems.

A vehicle driver or driving assist system and/or object detection system and/or alert system operates to capture sensor data and may process the captured sensor data to detect objects at or near a vehicle equipped with the system and in the predicted path of the equipped vehicle, such as to assist a driver with detecting an emergency vehicle. The alert system includes a data processor or data processing system that is operable to receive sensor data from one or more sensors (e.g., microphones) and provide an output to a display device for displaying alerts associated with the captured sensor data.

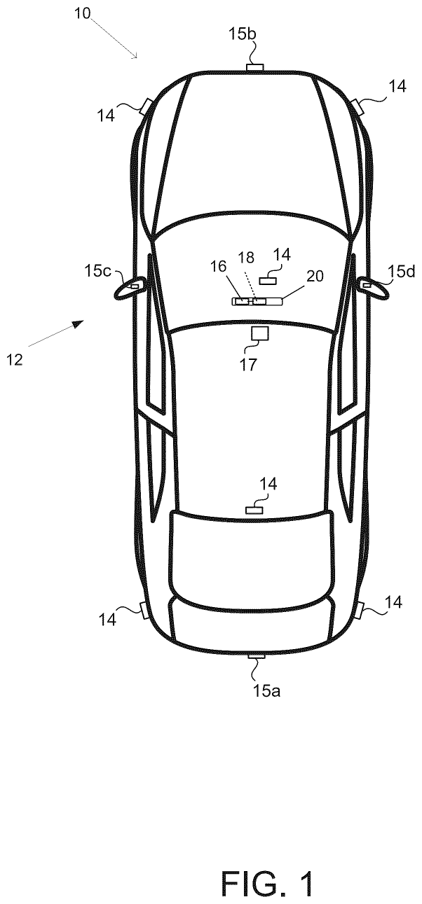

Referring now to the drawings and the illustrative embodiments depicted therein, a vehicle 10 includes an alert system or driving assist system 12 that includes at least one exterior sensing sensor, such as one or more microphones 14. In some examples, the vehicle includes one or more image sensors, such as a rear backup camera or rearward viewing imaging sensor or camera 15a (and the system may optionally include multiple exterior viewing imaging sensors or cameras, such as a forward viewing camera 15b at the front (or at the windshield) of the vehicle, and sideward/rearward viewing cameras 15c, 15d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The alert system 12 includes a control or electronic control unit (ECU) 18 having electronic circuitry and associated software, with the electronic circuitry including a data processor or image processor that is operable to process sensor data captured by the sensors and/or image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). Optionally, the system includes other output devices, such as one or more speakers 17. The data transfer or signal communication from the sensors and/or camera to the ECU (e.g., to transfer captured sensor data, such as audio data) may comprise any suitable data or communication link, such as a vehicle network bus or the like of the equipped vehicle.

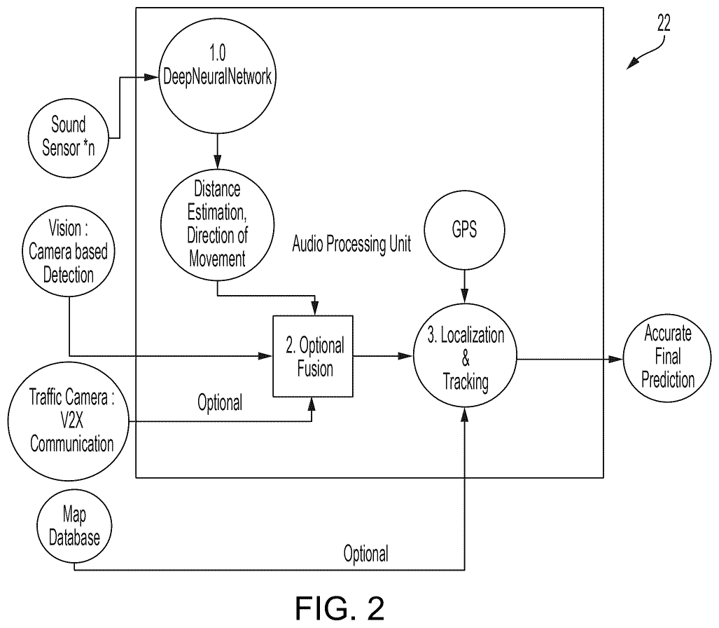

Referring now to FIG. 2, an exemplary block diagram 22 of the alert system or vehicular driving assist system 12 is depicted, which includes acoustic sensors such as microphones 14 mounted on the exterior of the equipped vehicle. The acoustic sensors may be positioned directionally on corners of the equipped vehicle (FIG. 1), such that each acoustic sensor is oriented in a different direction from the other acoustic sensors. The direction of a sound received at one or more of the acoustic sensors is determined mathematically based on time of arrival of the sound at each of the acoustic sensors and a phase associated with the acoustic sensors. The sound information is transmitted to a central processing unit (CPU) such as the ECU 18 for processing. The CPU may implement sound processing, filtering and, additionally or alternatively, artificial intelligence based (AI-based) sound recognition to identify an approaching emergency vehicle. The information from various acoustic sensors is used to estimate or predict or determine a direction of the sound source with respect to the equipped vehicle. The identified information and direction may be converted to an output and sent to a display unit, such as an instrument panel, infotainment system, or heads-up display unit, to notify the driver. The display unit may represent the output as a visual notification that may include graphical representations, such as arrows or icons, indicating the direction from which the emergency vehicle is approaching (i.e., a direction of travel of the emergency vehicle), as well as textual alerts or color-coded signals to draw the driver's attention.

In addition to or as an alternative to visual notifications, the system may provide audible alerts (e.g., via the speaker 17) to facilitate the driver's awareness of the oncoming emergency vehicle. The system may isolate the emergency vehicle sounds from the noisy exterior audio input stream (i.e., isolate the emergency vehicle sounds from ambient noise exterior of the equipped vehicle) and amplify and provide the isolated emergency vehicle sounds as a sole input to the equipped vehicle's audio system. Alternatively, the isolated emergency vehicle sounds may be mixed with existing audio being played in the equipped vehicle, ensuring that the driver hears the emergency vehicle's siren over any music or other audio content. The volume of the existing audio may be reduced relative to the emergency vehicle sounds. In some configurations, the system may mute and replace the existing audio with the isolated emergency vehicle sounds, providing a clear and unmistakable audio alert. This dual-mode notification system, combining both visual and audible alerts, enhances the driver's situational awareness and may increase timely and appropriate responses by the driver to the presence of emergency vehicles.

As shown in FIG. 2, a model, such as a neural network (e.g., a deep neural network or the like) receives sensor data (e.g., audio data) from one or more microphones or other sound sensors. The model estimates or predicts a distance and a direction of movement (i.e., a direction of travel) of one or more emergency vehicles with respect to the equipped vehicle based on the sensor data. Optionally, these predictions are fused with other sensor data, such as image data captured by one or more cameras (which may capture images of emergency vehicles, such as flashing lights). For example, image data captured by a front camera module (FCM) or one or more surround view cameras is fused with the predictions from the model. This fusion may raise the precision of the overall prediction, such as when the emergency vehicle is on the same road as the equipped vehicle or is near an intersection at which the equipped vehicle is located.

The fusion additionally or alternatively includes vehicle-to-infrastructure (V2X) communications. For example, the V2X communications include information from sensor nodes that are stationary (e.g., smart traffic signals). More particularly, a traffic signal could include a camera that captures image data of an emergency vehicle. The traffic signal may detect the emergency vehicle based on this image data and communicate the presence of the emergency vehicle to the equipped vehicle (e.g., by broadcasting this information to all nearby vehicles using short range radio communications). In some examples, the equipped vehicle may communicate emergency vehicle detections to a stationary node via the vehicular driving assist system, such that the stationary node may communicate the detection to all nearby vehicles. Optionally, V2X communications and smart mirrors may be combined by the vehicular driving assist system to increase emergency vehicle predictions. Additionally or alternatively, the fusion may include vehicle-to-vehicle (V2V) communications including audio data or image data collected from sensors of other vehicles.

The system may provide localization and tracking based on a map database and, for example, a GPS sensor to further refine or update the predictions. The prediction(s) from the model and/or fusion outputs may be integrated with data from a map provider. The map provider provides data with respect to roads, lanes, and/or lane information. A Kalman filter may be utilized for the purpose of tracking each detected or predicted emergency vehicle. The resulting tracked vehicles are correlated with lane information derived from high-definition (HD) map data. Utilizing this information along with the in-car GPS system, the alert system may accurately position the emergency vehicle(s) and the equipped vehicle within a virtual traffic scene. This information may be transmitted to a display device to enhance the driver's situational awareness. Optionally, the virtual scenario may be simplified to provide textual information regarding the approaching emergency vehicle.

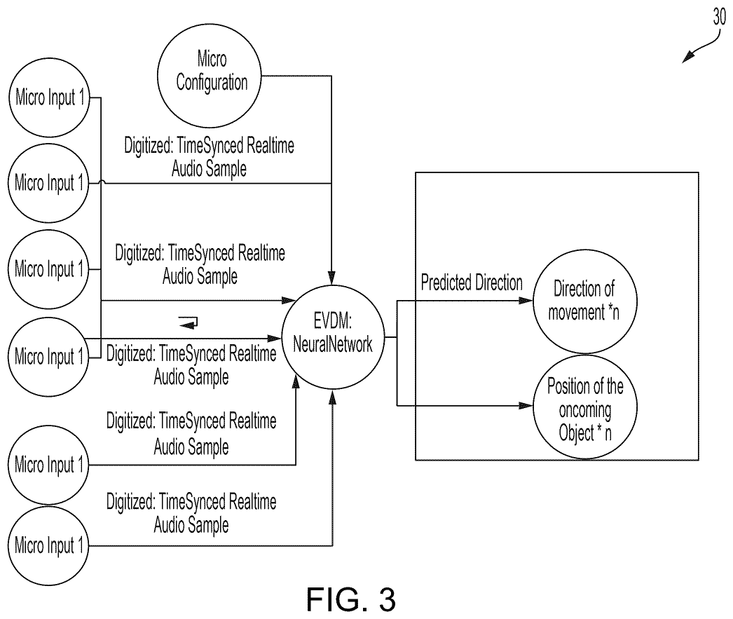

FIG. 3 illustrates a block diagram 30 for the model. Here, the model receives digitized and time-synchronized real-time audio samples from the sensors. Based on this data, the model predicts a position and a direction of movement for one or more emergency vehicles, such as a position and a direction of movement for the one or more emergency vehicles relative to the equipped vehicle. To train the model, a dataset of audio recordings from various scenarios using a standardized setup is collected or obtained. In the data collection setup, multiple microphone sensors, for example 3 to 6 or more, are connected to the equipped vehicle and/or to a data collection vehicle at varying heights and distances from the vehicle's center (e.g., using hangers). This setup is designed to capture the acoustic behavior of vehicles of various sizes, ranging from cars to trucks. Recordings from various scenarios may be taken and aggregated (e.g., into a data lake or other data repository). During the training phase, a model trainer obtains samples from the data lake, selects a configuration of the microphones, and trains the model using the sampled input.

Thus, the model (e.g., a deep neural network) is designed and trained to process digitized audio samples as inputs and generate an array of object information as outputs. Each object information entry may include multiple parameters, such as the direction of the oncoming movement and the distance of the oncoming object. Other optional parameters can be trained to predict the type of the oncoming emergency vehicle, such as whether it is a police car, fire truck, or ambulance. The model deciphers the type of emergency vehicle by extracting features embedded within the audio information.

Advantageously, the model is capable of predicting multiple emergency vehicles simultaneously. This capability assists the driver of the equipped vehicle when multiple emergency vehicles are approaching from different directions or in a sequential manner, a scenario where analog models may struggle or require complex implementations.

Thus, the alert system described herein includes one or more acoustic sensors, such as microphones, mounted on the exterior and/or interior of a vehicle to detect sounds from approaching emergency vehicles. These sounds are processed by an ECU or the like, which may use sound filtering and Al-based recognition to identify the emergency vehicle and determine its direction. The system can display this information to a driver of the equipped vehicle via various in-car displays and provide audio feedback by isolating and amplifying the emergency vehicle sounds. A neural network model may process the audio data from the sensors to predict the distance and direction of the emergency vehicle, potentially fusing this data with image data from cameras or vehicle-to-infrastructure (V2X) and/or vehicle-to-vehicle (V2V) communications for enhanced accuracy. The system may also integrate GPS and map data to refine predictions and track the emergency vehicle's position relative to the equipped vehicle. The model is trained using a dataset of audio recordings from various scenarios, enabling it to predict multiple emergency vehicles simultaneously and identify their types, such as police cars, fire trucks, or ambulances.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a plurality of microphones disposed at a vehicle equipped with the vehicular driving assist system and sensing exterior of the equipped vehicle, the plurality of microphones capturing audio data;
an electronic control unit (ECU) comprising electronic circuitry and associated software;
wherein audio data captured by the plurality of microphones is transferred to the ECU;
wherein the electronic circuitry of the ECU comprises a data processor, and wherein the data processor is operable to process audio data captured by the plurality of microphones and transferred to the ECU;
wherein the vehicular driving assist system, via processing at the ECU of captured audio data, determines presence of a plurality of emergency vehicles;
wherein the vehicular driving assist system, for each determined emergency vehicle of the plurality of emergency vehicles, determines (i) a position of the determined emergency vehicle and (ii) a direction of travel of the determined emergency vehicle; and
wherein the vehicular driving assist system generates an alert to a driver of the equipped vehicle, and wherein the alert indicates the position of each determined emergency vehicle and the direction of travel of each determined emergency vehicle.

2. The vehicular driving assist system of claim 1, further comprising an exterior-viewing camera disposed at the equipped vehicle and viewing exterior of the equipped vehicle, wherein image data captured by the camera is transferred to the ECU, and wherein the vehicular driving assist system determines presence of the plurality of emergency vehicles at least in part via processing at the ECU of image data captured by the exterior-viewing camera.

3. The vehicular driving assist system of claim 1, wherein the vehicular driving assist system determines presence of the plurality of emergency vehicles based at least in part on a wireless communication.

4. The vehicular driving assist system of claim 3, wherein the wireless communication is transmitted by a traffic signal.

5. The vehicular driving assist system of claim 1, wherein the vehicular driving assist system determines presence of the plurality of emergency vehicles using a deep neural network.

6. The vehicular driving assist system of claim 5, wherein the deep neural network is trained using a dataset of audio recordings from a plurality of traffic scenarios.

7. The vehicular driving assist system of claim 1, wherein the alert comprises a visual notification.

8. The vehicular driving assist system of claim 1, wherein the alert comprises an audible notification.

9. The vehicular driving assist system of claim 8, wherein the audible notification is mixed with existing audio being played in the equipped vehicle.

10. The vehicular driving assist system of claim 8, wherein the audible notification mutes and replaces existing audio being played in the equipped vehicle.

11. The vehicular driving assist system of claim 1, wherein the vehicular driving assist system refines the determined position of each determined emergency vehicle based on a map database and GPS data indicating a current location of the equipped vehicle.

12. The vehicular driving assist system of claim 1, wherein the vehicular driving assist system tracks each determined emergency vehicle based on a Kalman filter.

13. The vehicular driving assist system of claim 1, wherein the vehicular driving assist system determines, for each determined emergency vehicle, that the determined emergency vehicle is one selected from the group consisting of (i) a police vehicle, (ii) a fire truck and (iii) an ambulance.

14. A method for vehicular driving assistance, the method comprising:
capturing audio data via a plurality of microphones disposed at a vehicle equipped with a vehicular driving assist system, the plurality of microphones sensing an exterior of the equipped vehicle;
transferring the audio data captured by the plurality of microphones to an electronic control unit (ECU) comprising electronic circuitry and associated software;
processing, by a data processor of the electronic circuitry of the ECU, the audio data transferred to the ECU;
determining, by the vehicular driving assist system via the processing at the ECU of the audio data, presence of a plurality of emergency vehicles;
determining, by the vehicular driving assist system for each determined emergency vehicle of the plurality of emergency vehicles, (i) a position of the determined emergency vehicle and (ii) a direction of travel of the determined emergency vehicle; and
generating, by the vehicular driving assist system, an alert to a driver of the equipped vehicle, wherein the alert indicates the position of each determined emergency vehicle and the direction of travel of each determined emergency vehicle.

15. The method of claim 14, further comprising capturing image data via an exterior-viewing camera disposed at the equipped vehicle and viewing an exterior of the equipped vehicle, wherein the image data captured by the camera is transferred to the ECU, and wherein determining the presence of the plurality of emergency vehicles is performed at least in part via processing at the ECU of the image data captured by the exterior-viewing camera.

16. The method of claim 14, wherein determining the presence of the plurality of emergency vehicles is based at least in part on a wireless communication.

17. The method of claim 16, wherein the wireless communication is transmitted by a traffic signal.

18. The method of claim 14, wherein determining the presence of the plurality of emergency vehicles is performed using a deep neural network.

19. The method of claim 18, wherein the deep neural network is trained using a dataset of audio recordings from a plurality of traffic scenarios.

20. The method of claim 14, wherein the alert comprises a visual notification.
